(19) United States
(12) Patent Application Publication
(10) Pub. No.: US 2001/0047479 A1
(43) Pub. Date: Nov. 29, 2001

(54) Method and apparatus for checking access authorization for a system

(76) Inventors: Manfred Bromba, Munchen (DE); Bernhard Raaf, Munchen (DE)

Correspondence Address: LERNER AND GREENBERG, P.A., Post Office Box 2480, Hollywood, FL, 33022-2480, US

(21) Appl. No.: 09/815,200

(22) Filed: Mar. 22, 2001

Related U.S. Application Data
(63) Continuation of application No. PCT/DE99/02828, filed on Sep. 6, 1999.

(30) Foreign Application Priority Data
Sep. 22, 1998 (DE) 198 43 440.5

(51) Int. Cl. H04L 9/32

(52) U.S. Cl. 713/186

(57) ABSTRACT

The present invention relates to a method for checking access authorization for a system. A modified code is stored in the system in advance. An access authorization code is stored in a part of the system which users cannot access or have difficulty accessing. The modified code is different from the access code. Biological features of a user are detected and are compared with features that are stored in the system. If the features match, a computation rule is used to calculate a code from the modified code, the calculated code is transmitted to the part of the system which users cannot access, and there, it is checked using the stored access authorization code. The invention also relates to an apparatus for checking access authorization for a system.

### CROSS-REFERENCE TO RELATED APPLICATION

This application is a continuation of copending International Application No. PCT/DE99/02828, filed Sep. 6, 1999, which designated the United States.

### BACKGROUND OF THE INVENTION

Field of the Invention

The present invention relates to a method and an apparatus for checking access authorization for a system.

Such a system may be a mobile telephone, for example. In mobile telephones, it is customary to use a so-called PIN code to authorize access. In this context, in order to be able to make a call, the user needs to enter a particular PIN code known only to him. The mobile telephone checks this PIN code and, if the check is positive, unblocks the mobile telephone to enable calls to be made.

In addition, biometric identification methods have recently been developed in which biological features of a user are used for authentication purposes. Such biometric identification is a complex but convenient and often very reliable method of ensuring that a particular person is associated with and can access a service, an object or a place. In this context, the advantage of biometric identification over the PIN code is that it cannot be forgotten, and the biometric feature or features can only be copied with very great difficulty, or cannot be copied at all. This is because, whereas the PIN code is pure software, biometric features always have a more or less unique association with hardware, i.e. with the body of the authorized user. Since the PIN code entails the entry of digits or text, which usually requires a series of key strokes, this always results in diminished convenience, and hence sometimes in the security measures being bypassed. For example, with some mobile radio services, the user is able to turn off the PIN code completely, at his own risk. Mobile radio services do not require acknowledgement of each individual telephone call by entry of the PIN code. This means that, once it has been turned on, a mobile telephone can be used by any third parties and hence also by unauthorized persons at the cost of the owner of the mobile telephone. Modern mobile telephones are increasingly being designed to try to limit the entry of digits required for telephone numbers in cases involving emergencies. Attempts are even being made to manage with mobile telephones having no keypad at all for some applications. In this case, distinctive biometric identification, if it is possible with little effort, is very advantageous.

In current mobile telephones, however, a problem arises in a PIN code is required to be stored on the SIM card in order to conform to the GSM standard. In accordance with the GSM standard, this PIN code must not be additionally stored in the mobile telephone itself. The problem that this poses is that the PIN code cannot be replaced by biometric identification without changing the GSM standard.

A further use for biometric identification resides, for example, in computers communicating with external service providers over a network, such as the Internet. Such communication, for example with financial institutions, also requires reliable authentication. PIN codes have also been used in this area to date.

### SUMMARY OF THE INVENTION

It is accordingly an object of the invention to provide an apparatus for checking whether access to a system is authorized and a corresponding method which overcomes the above-mentioned disadvantageous of the prior art apparatus and methods of this general type. In particular, it is an object of the invention to provide a method and an apparatus in which the authentication involves using biological features of the user, and where the method and the apparatus can be used in conjunction with systems that require a conventional access authorization code to be stored in a part of the system that cannot be accessed by the user.

With the foregoing and other objects in view there is provided, in accordance with the invention, a method for checking access authorization for a system, that includes steps of: providing a system having a portion that is at least difficult for a user to access; storing an access authorization code in the portion of the system that is at least difficult for the user to access; in the system, storing a modified code that is different from the access authorization code; subsequent to storing the modified code, detecting biological features of a user; and comparing the detected biological features with predetermined features that have been stored in the system. If the detected biological features match the predetermined features that have been stored, then the method includes steps of: using a computation rule to calculate a calculated code from the modified code; transmitting the calculated code to the portion of the system that is at least difficult for the user to access; and in the portion of the system that is at least difficult for the user to access, comparing the calculated code with the access authorization code that has been stored.

With the foregoing and other objects in view there is also provided, in accordance with the invention, an apparatus for checking access authorization for a system. The apparatus includes a first memory unit for storing an access authorization code. The first memory unit is configured to be difficult to access by a user. A second memory unit is provided for storing a modified code that is different than the access authorization code. The second memory unit is also for storing biological features. An input unit for entering and detecting biological features of a user is provided. A first comparator unit is connected to the input unit for receiving the detected biological features and is connected to the second memory unit for receiving the stored biological features. The first comparator unit is configured for comparing the detected biological features with the stored biological features and for outputting an access authorization signal if the detected biological features match the stored biological features. A second comparator unit is connected to the first memory unit. A processor is connected to the first comparator unit, the second memory unit, and the second comparator unit. The processor is configured for calculating a code from the modified code using a computation rule based on the access authorization signal from the first comparator unit. The processor is also configured for transmitting the calculated code to the second comparator unit. The second comparator unit is configured for comparing the calculated code transmitted by the processor with the access authorization code stored in the first memory unit and, if there is a match, granting access authorization.

An advantage of the inventive method and apparatus is that biometric identification is made possible in conjunction with a system which uses conventional access authorization codes stored in a part of the system which users cannot access. This makes it a particularly simple matter to use the invention in already existing systems without changing any standards.

In accordance with an added feature of the invention, the code is calculated using the computation rule on the basis of the modified code and at least some of the biological features. An advantage of this refinement is that, for third parties aiming to gain unauthorized access to the system, calculation of the code is made particularly difficult since the code cannot be calculated without knowledge of the biological features of the authorized user.

In accordance with an additional feature of the invention, the system is a mobile telephone with a SIM card, where the access authorization code is advantageously stored on the SIM card in encrypted form, and the biological features to be checked and the modified code are stored in a read only memory of the mobile telephone. An advantage of this development for mobile telephones is that the mobile telephone still satisfies the GSM standard, since the access authorization code, i.e. the PIN number, is not stored in a memory of the mobile telephone itself, but rather only in the SIM card. The read only memory of the mobile telephone contains only the modified code, which cannot be used by an unauthorized third party.

In accordance with a further feature of the invention, the system includes a computer and an external unit which communicate with one another via an interface, in the course of which the access authorization of a user using the computer to request access to the external unit is checked. In this case, the first memory, which stores the access authorization code, can be provided in the external unit, which the user cannot access. By way of example, the first memory is the memory of a bank. The second memory, which contains the biological features to be checked and the modified code, can be the read only memory of the computer itself. In this case too, the conventional check on access authorization using PIN codes need not be changed, even though authentication of the user uses biological features.

In accordance with a concomitant feature of the invention, the biological features can be obtained from the fingerprint or from the iris of an eye of a user.

Other features which are considered as characteristic for the invention are set forth in the appended claims.

Although the invention is illustrated and described herein as embodied in a method and apparatus for checking the access authorization for a system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 shows a schematic diagram of an illustrative embodiment of the invention; and

FIG. 2 shows a flowchart to explain the illustrative embodiment of the invention.

### DESCRIPTION OF THE PREFERRED EMBODIMENTS

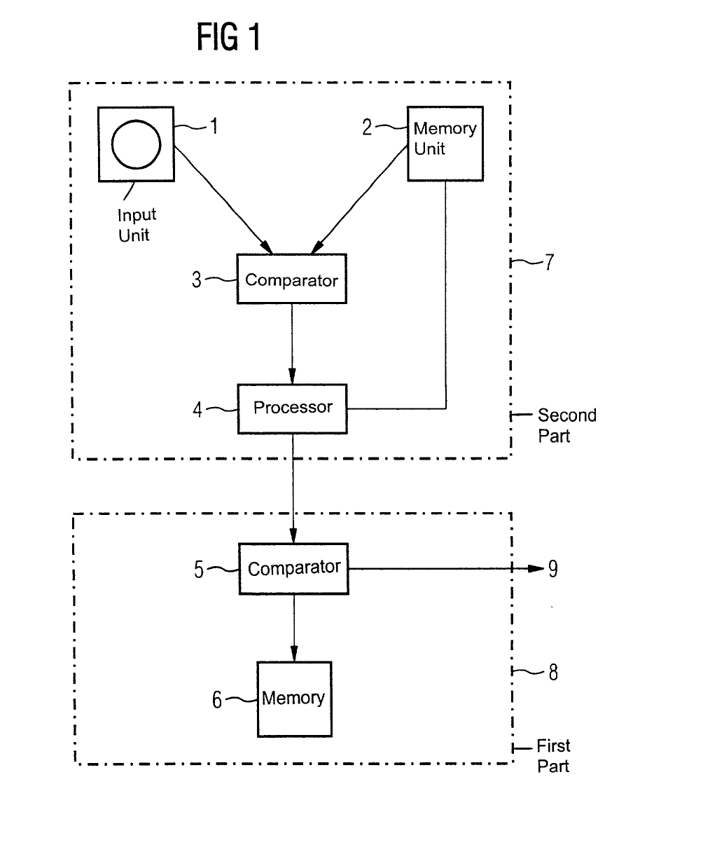

Referring now to the figures of the drawing in detail and first, particularly, to FIG. 1 thereof, there is shown an illustrative embodiment of an apparatus that is split into two parts. A first part 8 cannot be accessed by a user, or is very difficult to access. By way of example, this part may be the SIM card of a mobile telephone or the central computer of a bank.

The second part 7 of the apparatus is easier for a user to access. By way of example, this part is a mobile telephone or a computer communicating with external services over the Internet.

The second part 7 has an input unit 1 which can be used to detect biological features and to convert them such that they can be compared with stored features. By way of example, the input unit 1 is a fingerprint detector or a detector for the iris of an eye.

The part 7 also has a memory unit 2 which stores the biological features detected by the input unit 1 as data when the apparatus is initialized. In addition, a modified code is stored in the memory unit 2 or in a memory unit provided separately from this memory unit 2 when the apparatus is initialized.

A comparator unit 3 is connected both to the input unit 1 and to the memory unit 2. The input unit 1 transmits the detected biological features to the comparator unit 3, and there they are compared with the stored features, which the comparator unit 3 receives from the memory unit 2. If the result of this comparison is positive, i.e. if the detected biological features match the stored features, the memory unit 3 transmits a signal to a processor 4.

Once this signal has been received from the comparator unit 3, the processor 4 calculates a code from the modified code stored in the memory unit 2 and preferably from at least some biological features which have been detected by the input unit. This calculated code needs to be transmitted to the part 8 which users cannot access.

In this way, the devices 1 to 4 of the apparatus according to the invention replace direct entry of a PIN code, for example, using an input unit. For this reason, the subsequent devices in the apparatus, i.e. particularly the apparatuses provided in the part 8 of the apparatus which users cannot access, can remain unchanged as compared with conventional apparatuses. This means that there is no need to change a standard which is set for this part 8.

The processor 4 transmits the code it has calculated to a second comparator unit 5. This unit compares the calculated code with the access authorization code stored in the memory unit 6. By way of example, this access authorization code may be the PIN number stored in the SIM card. If the comparator unit 5 establishes a match between the calculated code and the access authorization code stored in the memory unit 6, the comparator unit 5 outputs an access authorization signal via the line 9. This access authorization signal informs the system which contains the apparatus according to the invention that the user whose biometric features have been detected by the input unit is an authorized user.

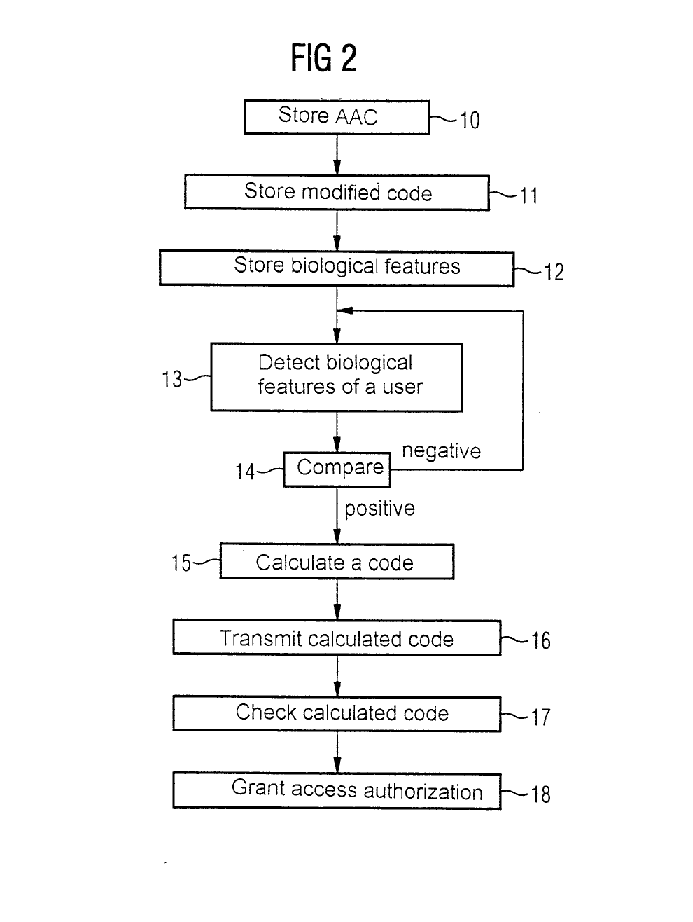

The method according to the invention is explained with reference to FIG. 2.

First, in step 10, the access authorization code is stored in a part of the system which users cannot access or have difficulty accessing. In addition, in step 11, a modified code, and in step 12, biological features are stored in another part of the system, which is easier for users to access. Steps 10 to 12 are carried out on initialization.

Next, a user's access authorization for a system needs to be checked. To this end, biological features of the user are detected in step 13. Then, in step 14, the detected biological features are compared with the biological features stored in advance in step 12. If the result of the comparison is negative, i.e. if it is established that the detected biological features do not match the stored features, the method returns to step 13, and access authorization is not granted.

If the result of the comparison in step 14 is positive, i.e. if the detected biological features match the biological features stored in advance, a computation rule is used to calculate a code from the modified code stored in step 11. The code is preferably calculated based on the stored modified code and the detected biological features of a user. This calculated code is then transmitted in step 16 to the part of the system which users cannot access. There, this calculated code is then checked using conventional methods in step 17, and the access authorization is then granted in step 18.

We claim:

1. A method for checking access authorization for a system, which comprises:
providing a system having a portion that is at least difficult for a user to access;
storing an access authorization code in the portion of the system that is at least difficult for the user to access;
in the system, storing a modified code that is different from the access authorization code;
subsequent to storing the modified code, detecting biological features of a user;
comparing the detected biological features with predetermined features that have been stored in the system; and
if the detected biological features match the predetermined features that have been stored, then:
using a computation rule to calculate a calculated code from the modified code,
transmitting the calculated code to the portion of the system that is at least difficult for the user to access, and
in the portion of the system that is at least difficult for the user to access, comparing the calculated code with the access authorization code that has been stored.

2. The method according to claim 1, which comprises basing the computation rule on the modified code and on at least some of the detected biological features.

3. The method according to claim 2, which comprises providing the system as a mobile telephone with a SIM card.

4. The method according to claim 2, which comprises:
providing the system as an interface, a computer, and an external unit that communicates with the computer via the interface; and
using the computer to communicate with the external unit via the interface to request that the user be authorized to access the external unit.

5. The method according to claim 1, which comprises providing the system as a mobile telephone with a SIM card.

6. The method according to claim 5, which comprises:
providing the SIM card as the portion of the system that is at least difficult to access so that the access authorization code is stored on the SIM card;
providing the mobile telephone with a read only memory;
storing the modified code in the read only memory of the mobile telephone; and
wherein the predetermined features that have been stored in the system have been stored in the read only memory of the mobile telephone.

7. The method according to claim 6, which comprises storing the access authorization code in encrypted form when storing the access authorization code on the SIM card.

8. The method according to claim 1, which comprises:
providing the system as an interface, a computer, and an external unit that communicates with the computer via the interface; and
using the computer to communicate with the external unit via the interface to request that the user be authorized to access the external unit.

9. The method according to claim 8, wherein:
the step of storing the access authorization code includes storing the access authorization code in the external unit;
the step of storing the modified code in the system includes storing the modified code in the computer; and
the predetermined features have been stored in the computer.

10. The method according to claim 1, wherein the step of detecting the biological features of the user includes detecting the biological features from a fingerprint of the user.

11. The method according to claim 1, wherein the step of detecting the biological features of the user includes detecting the biological features from an iris of an eye of the user.

12. The method according to claim 1, which comprises constructing the portion of the system that is at least difficult for a user to access so that the portion cannot be accessed by the user.

13. An apparatus for checking access authorization for a system, comprising:
a first memory unit for storing an access authorization code, said first memory unit configured to be difficult to access by a user;
a second memory unit, for storing a modified code that is different than the access authorization code, said second memory unit for storing biological features;
an input unit for entering and detecting biological features of a user;
a first comparator unit connected to said input unit for receiving the detected biological features and connected to said second memory unit for receiving the stored biological features, said first comparator unit configured for comparing the detected biological features with the stored biological features and for outputting an access authorization signal if the detected biological features match the stored biological features;
a second comparator unit connected to said first memory unit; and
a processor connected to said first comparator unit, said second memory unit, and said second comparator unit, said processor configured for calculating a code from the modified code using a computation rule based on the access authorization signal from said first comparator unit, said processor configured for transmitting the calculated code to said second comparator unit;
said second comparator unit configured for comparing the calculated code transmitted by said processor with the access authorization code stored in said first memory unit and, if there is a match, granting access authorization.

14. The apparatus according to claim 13, wherein the system is a mobile telephone with a SIM card.

15. The apparatus according to claim 14, wherein said SIM card includes said first memory unit, and said mobile telephone includes a read only memory defining said second memory unit.

16. The apparatus according to claim 15, wherein the access authorization code is stored in said first memory unit of said SIM card in encrypted form.

17. The apparatus according to claim 13, wherein the system includes an interface, a computer, and an external unit configured for communicating with said computer via said interface.

18. The apparatus according to claim 17, wherein said external unit includes said first memory unit, and said computer includes said second memory unit, said second memory unit being a read only memory.

19. The apparatus according to claim 13, wherein said input unit is a fingerprint input unit for detecting a fingerprint of the user.

20. The apparatus according to claim 13, wherein said input unit is configured to detect biological features from an iris of an eye of the user.

21. The apparatus according to claim 13, wherein said first memory unit is configured so that the user cannot have access thereto.
